(19) United States
(12) Patent Application Publication
(10) Pub. No.: US 2024/0151560 A1
(43) Pub. Date: May 9, 2024

(54) HOUSING AND SENSOR DEVICE

(71) Applicant: Murata Manufacturing Co., Ltd., Nagaokakyo-shi (JP)

(72) Inventors: Katsuhiro TABUCHI, Nagaokakyo-shi (JP); Katsumi FUJIMOTO, Nagaokakyo-shi (JP)

(21) Appl. No.: 18/416,941

(22) Filed: Jan. 19, 2024

Related U.S. Application Data
(63) Continuation of application No. PCT/JP2022/022636, filed on Jun. 3, 2022.

(30) Foreign Application Priority Data
Aug. 18, 2021 (JP) 2021-133492
Mar. 23, 2022 (JP) 2022-047370

(51) Int. Cl. G01D 11/24; B08B 7/02; B60S 1/56

(52) U.S. Cl. CPC G01D 11/245; B08B 7/02; B60S 1/56

(57) ABSTRACT

A housing containing an optical sensor, including a light-transmitting body, a housing base to contain the optical sensor, the housing base holding the light-transmitting body in such a way that the light-transmitting body is able to vibrate, and one or a plurality of actuators that vibrate the light-transmitting body. A sensor device includes the housing and the optical sensor contained in the housing.

### CROSS REFERENCE TO RELATED APPLICATIONS

This application claims the benefit of priority to Japanese Patent Application No. 2021-133492, filed on Aug. 18, 2021 and Japanese Patent Application No. 2022-047370, filed on Mar. 23, 2022, and is a Continuation Application of PCT Application No. PCT/JP2022/022636, filed on Jun. 3, 2022. The entire contents of each application are hereby incorporated herein by reference.

### BACKGROUND OF THE INVENTION

### 1. Field of the Invention

The present invention relates to housings of a sensor device and a sensor device.

### 2. Description of the Related Art

Waterdrops such as raindrops may adhere to a lens of a camera used outdoors, such as an on-vehicle camera or a security camera. Therefore, devices that can remove waterdrops adhering to a lens have been proposed.

For example, Japanese Unexamined Patent Application Publication No. 2013-080177 describes a camera having a waterdrop-removing function of removing waterdrops adhering to a lens of an image-capturing assembly. The camera having a waterdrop-removing function described in Japanese Unexamined Patent Application Publication No. 2013-080177 removes waterdrops adhering to the lens by vibrating the image-capturing assembly in a direction in which an optical axis moves.

The camera having a waterdrop-removing function described in Japanese Unexamined Patent Application Publication No. 2013-080177 has room for improvement in view of improvement of detection accuracy.

### SUMMARY OF THE INVENTION

Example embodiments of the present invention provide housings of a sensor device that each remove liquid drops by vibration, that are each able to improve the detection accuracy of the sensor device, and sensor devices.

A housing according to an example embodiment of the present invention includes an optical sensor including a light-transmitting body, a housing base to contain the optical sensor, the housing base holding the light-transmitting body such that the light-transmitting body is able to vibrate, and one or a plurality of actuators to vibrate the light-transmitting body.

A sensor device according to an example embodiment of the present invention includes a housing according to an example embodiment of the present invention and an optical sensor included in the housing.

Example embodiments of the present invention provide housings of a sensor device that each removes liquid drops by vibration, that are each able to improve the detection accuracy of the sensor device, and the sensor device.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a sensor device and a housing according to a first example embodiment of the present invention.

FIG. 2 is an exploded perspective view of the sensor device and the housing of FIG. 1.

FIG. 3 is an enlarged view of a region R1 of FIG. 2.

FIG. 4 is a sectional view taken along a line A-A of FIG. 1.

FIG. 5 is an enlarged view of a region R2 of FIG. 4.

FIG. 6 is a sectional view taken along a line B-B of FIG. 2.

FIG. 7 is a perspective view illustrating a housing according to a first modification of the first example embodiment of the present invention.

FIG. 8 is a sectional view taken along a line C-C of FIG. 7.

FIG. 9 is a perspective view illustrating a housing according to a second modification of the first example embodiment of the present invention.

FIG. 10 is a sectional view taken along a line D-D of FIG. 9.

FIG. 11 is a perspective view illustrating a portion of a sensor device according to a second example embodiment of the present invention.

FIG. 12 is a block diagram illustrating the configuration of a housing according to a third example embodiment of the present invention.

FIG. 13 is a perspective view illustrating a housing according to a fourth example embodiment of the present invention.

FIG. 14 is a perspective view illustrating a housing according to a fifth example embodiment of the present invention.

FIG. 15 is a perspective view of the housing of FIG. 14 a portion of which is omitted.

FIG. 16 is a sectional view taken along a line E-E of FIG. 15.

FIG. 17 is a sectional view taken along a line F-F of FIG. 14.

FIG. 18 is a schematic view illustrating a cushioning portion of FIG. 17.

FIG. 19 is a perspective view illustrating a housing according to a sixth example embodiment of the present invention.

FIG. 20 is a front view illustrating a housing base of the housing of FIG. 19.

FIG. 21 is a perspective view illustrating a light-transmitting body of the housing of FIG. 19.

FIG. 22 is an enlarged view of a region R3 of FIG. 20.

FIG. 23 illustrates an example of the vibration mode of the light-transmitting body.

FIG. 24 illustrates another example of the vibration mode of the light-transmitting body.

FIG. 25 illustrates an example of the vibration mode of the light-transmitting body in a housing base according to a modification of the sixth example embodiment of the present invention.

FIG. 26 is a perspective view illustrating a housing according to a seventh example embodiment of the present invention.

FIG. 27 is a block diagram illustrating the configuration of a housing according to an eighth example embodiment of the present invention.

FIG. 28 is a graph illustrating an example of a signal having a first resonant frequency.

FIG. 29 is a graph illustrating an example of a signal having a second resonant frequency.

FIG. 30 is a graph illustrating an example of a signal having a resonant frequency in which the first resonant frequency and the second resonant frequency are superposed.

FIG. 31 is a table showing maximum accelerations for moving foreign matter adhering to the light-transmitting body and frequencies that are effective in realizing the maximum accelerations.

### DETAILED DESCRIPTION OF THE EXAMPLE EMBODIMENTS

In recent years, control of autonomous driving of a vehicle has been performed by using information about the outside of the vehicle obtained by, for example, an optical sensor such as, for example, a LiDAR, a millimeter-wave radar, an infrared camera, an ordinary optical camera, or the like. Since such an optical sensor is usually disposed outside of a vehicle, a light-transmitting body to protect a lens of the sensor is exposed to wind and rain, and foreign matter such as rainwater or muddy water adheres to the light-transmitting body and may affect the performance of the sensor.

Therefore, as in a camera having a waterdrop-removing function described in Japanese Unexamined Patent Application Publication No. 2013-080177, devices for removing waterdrops and the like adhering to the lens by vibration have been examined. In the camera having a waterdrop-removing function described in Japanese Unexamined Patent Application Publication No. 2013-080177, a piezoelectric element is disposed in an image-capturing assembly, and the image-capturing assembly itself vibrates when the piezoelectric element is driven to remove waterdrops and the like. As a result, the camera has a problem in that it cannot obtain a clear image due to blur of a captured image.

Thus, the inventors of example embodiments of the present invention have discovered improvement of the detection accuracy of a sensor device, which removes foreign matter by vibrating a light-transmitting body, by preventing vibration of the light-transmitting body from being transmitted to an optical sensor in the sensor device.

A housing according to a first example embodiment of the present invention is preferably a housing including an optical sensor, including a light-transmitting body, a housing base to contain the optical sensor, the housing base holding the light-transmitting body such that the light-transmitting body is able to vibrate, and one or a plurality of actuators that vibrate the light-transmitting body.

With such a configuration, since vibration of the light-transmitting body is not transmitted to the optical sensor, it is possible to provide a housing of a sensor device that can improve detection accuracy.

In a housing according to a second example embodiment of the present invention, the one or plurality of actuators each may include a coil that generates a magnetic field when an electric current flows therethrough, a core that is inserted into a hollow of the coil and supports the light-transmitting body, and a magnet that attracts the core due to the magnetic field generated by the coil, and the one or plurality of actuators may vibrate the light-transmitting body in an axial direction of the core.

With such a configuration, it is possible to reduce stress on the actuators.

In a housing according to a third example embodiment of the present invention, the light-transmitting body may have a plate shape, the plurality of actuators may include a first actuator and a second actuator, and the first actuator may be located on one end portion side of the light-transmitting body, and the second actuator may be located on the other end portion side of the light-transmitting body opposite to the first actuator.

With such a configuration, it is possible to efficiently vibrate the light-transmitting body without obstructing a field of view.

In a housing according to a fourth example embodiment of the present invention, the first actuator and the second actuator may oppose each other.

With such a configuration, it is possible to efficiently vibrate the light-transmitting body.

A housing according to a fifth example embodiment of the present invention may further include a detector to detect an output voltage of at least one actuator among the first actuator and the second actuator.

With such a configuration, it is possible to detect the amplitude of vibration of the light-transmitting body and to adjust the amplitude of vibration to an appropriate amplitude.

A housing according to a sixth example embodiment of the present invention may further include a controller to control vibrations of the one or plurality of actuators. The controller may control vibrations of the plurality of actuators based on the output voltage of the at least one actuator detected by the detector.

With such a configuration, it is possible to realize sharp acceleration and deceleration of the vibrations.

In a housing according to a seventh example embodiment of the present invention, the plurality of actuators may vibrate the light-transmitting body in a direction that intersects a thickness direction of the light-transmitting body.

With such a configuration, since it is possible to vibrate the light-transmitting body without bringing about optical axis variation of the optical sensor, it is possible to improve detection accuracy.

In a housing according to an eighth example embodiment of the present invention, the light-transmitting body may have a plate shape including a first main surface positioned outside and a second main surface opposite to the first main surface, and the plurality of actuators may be located on the second main surface side of the light-transmitting body.

With such a configuration, it is possible to reduce the height and improve the design of the sensor device.

In a housing according to a ninth example embodiment of the present invention, the plurality of actuators may vibrate the light-transmitting body in a thickness direction of the light-transmitting body.

With such a configuration, it is possible to make foreign matter adhering to the light-transmitting body easy to be removed by deforming the foreign matter by vibration.

In a housing according to a tenth example embodiment of the present invention, the light-transmitting body may have a cylindrical shape including a first end portion and a second end portion opposite to the first end portion, and the plurality of actuators may be located at regular intervals on at least one of the first end portion side and the second end portion side.

With such a configuration, the housing can be used also for an optical sensor having a wide-angled field of view.

In a housing according to an eleventh example embodiment of the present invention, the plurality of actuators may vibrate the light-transmitting body in an axial direction of the cylindrical shape.

With such a configuration, since it is possible to vibrate the light-transmitting body without bringing about optical axis variation of the optical sensor, it is possible to improve detection accuracy.

In a housing according to a twelfth example embodiment of the present invention, the actuator may include a piezoelectric element, the housing base may include a vibration-transmitting portion that connects the actuator and the light-transmitting body and transmits vibration to the light-transmitting body, the light-transmitting body may have a plate shape having a first main surface positioned outside, a second main surface opposite to the first main surface, and a side surface connecting the first main surface and the second main surface, the vibration-transmitting portion may include a first vibration-transmitting portion and a second vibration-transmitting portion, the first vibration-transmitting portion and the second vibration-transmitting portion each may include a vibration portion and a support portion, the vibration portion having one end portion and the other end portion, the one end portion being connected to the actuator, and extending along the side surface, the support portion extending from the other end portion of the vibration portion toward the side surface and supporting the light-transmitting body, and the support portions, respectively, of the first vibration-transmitting portion and the second vibration-transmitting portion may be disposed to oppose each other and support the side surface of the light-transmitting body therebetween.

With such a configuration, it is possible to remove foreign matter by efficiently vibrating the light-transmitting body while reducing power consumption.

In a housing according to a thirteenth example embodiment of the present invention, the actuator may vibrate in a first direction that intersects a direction in which the support portions, respectively, of the first vibration-transmitting portion and the second vibration-transmitting portion oppose each other and in which the first main surface of the light-transmitting body extends, and the support portions may be disposed at a center of the side surface in the first direction.

With such a configuration, it is possible to cause adhered foreign matter to slide down in the gravitational direction by vibrating the light-transmitting body upward and downward, and it is possible to remove adhered foreign matter in the thickness direction of the light-transmitting body by vibrating the light-transmitting body so as to rotate around the holding portion.

In a housing according to a fourteenth example embodiment of the present invention, the actuator may vibrate in a first direction that intersects a direction in which the support portions, respectively, of the first vibration-transmitting portion and the second vibration-transmitting portion oppose each other and in which the first main surface of the light-transmitting body extends, and the support portions may be disposed at positions that are closer to the actuator than to a center in the first direction.

With such a configuration, since it is possible to vibrate a portion of the light-transmitting body opposite to the actuator, it is possible to more efficiently remove foreign matter.

In a housing according to a fifteenth example embodiment of the present invention, the one or plurality of actuators each may include a unimorph or bimorph piezoelectric element, and the housing base may include a frame that supports the light-transmitting body and a connection portion that connects the light-transmitting body and the one or plurality of actuators.

With such a configuration, it is possible to efficiently vibrate the light-transmitting body with a simpler and smaller configuration.

In a housing according to a sixteenth example embodiment of the present invention, the housing may further include a controller that controls the actuator, and the controller may cause the actuator to vibrate at a modulation frequency in which a first resonant frequency of the actuator and a second resonant frequency of foreign matter adhering to the light-transmitting body are superposed.

With such a configuration, since it is possible to provide vibration close to the resonant frequency of the foreign matter, it is possible to efficiently remove foreign matter adhering to the light-transmitting body by promoting deformation of the foreign matter.

In a housing according to a seventeenth example embodiment of the present invention, the housing base may include an elastic body that absorbs vibration of the light-transmitting body.

With such a configuration, the elastic body can absorb vibration of the light-transmitting body. Therefore, vibration becomes unlikely to be transmitted to the optical sensor, and it is possible to suppress blur of a sensor image.

In a housing according to an eighteenth example embodiment of the present invention, a cushioning portion may be disposed between the light-transmitting body and the housing base or between the light-transmitting body and the optical sensor.

With such a configuration, it is possible to suppress entry of dirt or foreign matter to the inside of the housing or to the inside of the optical sensor.

In a housing according to a nineteenth example embodiment of the present invention, the cushioning portion may include a bellows structure.

With such a configuration, it is possible to suppress entry of dirt or foreign matter to the inside by closing the gap between the light-transmitting body and the optical sensor without transmitting vibration of the light-transmitting body to the optical sensor.

In a housing according to a twentieth example embodiment of the present invention, the cushioning portion may be made of an elastomer.

With such a configuration, it is possible to suppress entry of dirt or foreign matter to the inside of the housing or to the inside of the optical sensor.

A sensor device according to a twenty-first example embodiment of the present invention includes the housing described above, and an optical sensor contained in the housing.

With such a configuration, it is possible to provide a sensor device that can improve detection accuracy.

Hereafter, an example embodiment of the present invention will be described with reference to the drawings. The following description is essentially only an example and is not intended to limit the present invention, the application thereof, or the use thereof. Moreover, the drawings are schematic, and the ratios of dimensions and the like do not necessarily coincide with actual ones.

### First Example Embodiment

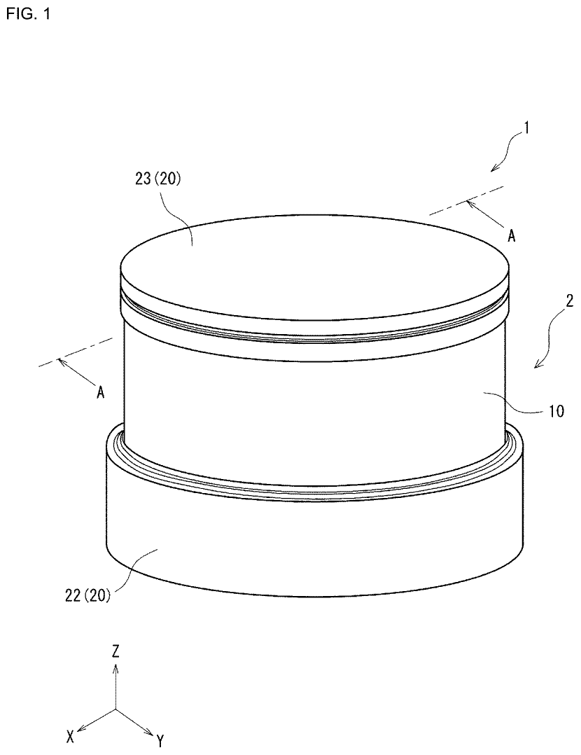

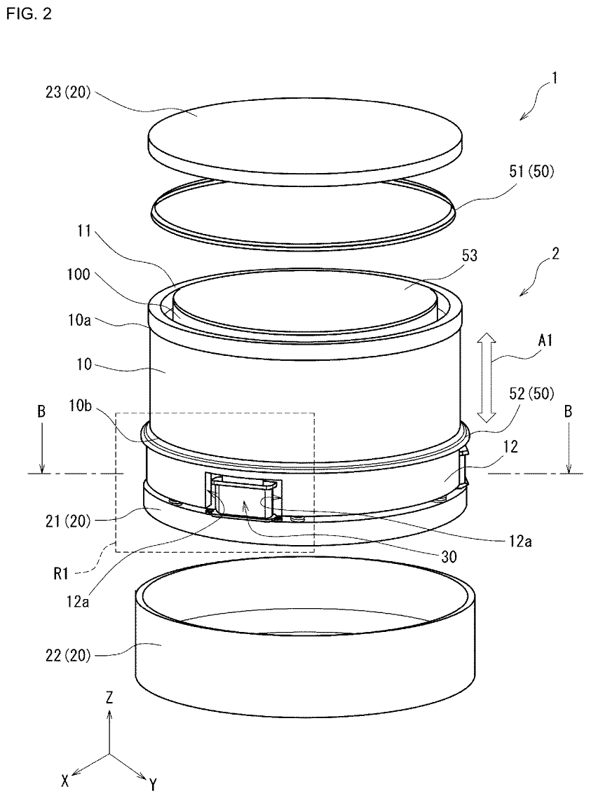

FIG. 1 is a perspective view illustrating a sensor device 1 and a housing 2 according to a first example embodiment of the present invention. FIG. 2 is an exploded perspective view of the sensor device 1 of FIG. 1. In the drawings, the X direction is the longitudinal direction of the sensor device 1, the Y direction is the transversal direction of the sensor device 1, and the Z direction is the height direction of the sensor device 1.

### Sensor Device

The sensor device 1 preferably includes the housing 2 and an optical sensor 100 inside of the housing 2.

Examples of the optical sensor 100 include, for example, a LiDAR, a millimeter-wave radar, an infrared camera, and an optical camera. The housing 2, for containing such an optical sensor, is used, for example, for a sensor device that searches for outside information necessary for autonomous driving of a vehicle.

### Housing

As illustrated in FIGS. 1 and 2, the housing 2 contains the optical sensor 100 inside thereof. The housing 2, inside of which the optical sensor 100 is contained, can be used as a sensor device.

The housing 2 preferably includes a light-transmitting body 10, a housing base 20, and an actuator 30. Light-Transmitting

### Body

The light-transmitting body 10 is a cover that prevents dirt or foreign matter from adhering to the optical sensor in the housing 2. The light-transmitting body 10 is made of a transparent material so as not to obstruct the field of view of the optical sensor 100.

As the material of the light-transmitting body 10, it is possible to use, for example, glass such as soda-lime glass, borosilicate glass, aluminosilicate glass, or silica glass; light-transmitting plastic; light-transmitting ceramic; or synthetic resin. It is possible to increase the strength of the light-transmitting body 10 by making the light-transmitting body 10 from, for example, tempered glass whose strength has been increased by chemical strengthening. In order to reduce adhesion of dirt, the surface of the light-transmitting body 10 may have a dirt-resistant coating or a water-repellent coating. In order to increase the transmittance of light having a desirable wavelength, the surface of the light-transmitting body 10 may have an antireflection coating.

In the present example embodiment, the light-transmitting body 10 preferably has a cylindrical or substantially cylindrical shape having a first end portion 10a and a second end portion 10b opposite to the first end portion 10a. When the light-transmitting body 10 has a cylindrical or substantially cylindrical shape, it is possible to improve detection accuracy without obstructing the field of view of the optical sensor 100 even if the optical sensor 100 has, for example, a field of view of 360 degrees along the XY-plane.

In the present example embodiment, a first holder 11 is located on the first end portion (upper end) 10a of the light-transmitting body 10 and a second holder 12 is located on the second end portion (lower end) 10b of the light-transmitting body. The holders 11 and 12 are optional. The holders 11 and 12 can prevent breakage of the light-transmitting body 10.

The holder 11 preferably has a ring shape and holds the first end portion 10a of the light-transmitting body 10. The holder 12 also preferably has a ring shape and holds the second end portion 10b of the light-transmitting body 10.

As illustrated in FIG. 2, a recessed portion 12a is provided in the holder 12, and an actuator 30 (described below) is disposed in the recessed portion 12a of the holder 12.

### Housing Base

The housing base 20 includes the optical sensor 100 and holds the light-transmitting body 10 such that the light-transmitting body 10 is able to vibrate. In the present example embodiment, the housing base 20 preferably includes a first base 23 that holds the first end portion 10a of the light-transmitting body 10, a second base 21 that holds the second end portion 10b of the light-transmitting body 10, and a body 22 that contains the optical sensor 100. In the present example embodiment, the optical sensor 100 is located inside of the light-transmitting body 10 having a cylindrical or substantially cylindrical shape, the first base 23 is located on the first end portion 10a side of the light-transmitting body 10, and the second base 21 and the body 22 are located on the second end portion 10b side of the light-transmitting body 10. In this way, the optical sensor 100 is included in the housing base 20.

As the material of the housing base 20, it is possible to use, for example, a metal, ceramics, a synthetic resin, or the like.

### Actuator

The actuator 30 vibrates the light-transmitting body 10. In the present example embodiment, the actuator 30 vibrates the light-transmitting body 10 in the height direction (the Z direction). As described below, in the present example embodiment, three actuators 30 are disposed.

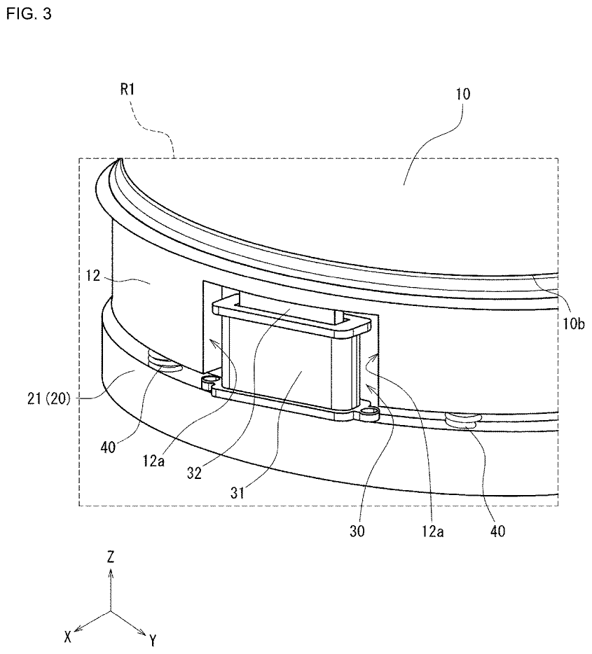

FIG. 3 is an enlarged view of a region R1 of FIG. 2. As illustrated in FIGS. 2 and 3, the actuator 30 is disposed so as to connect the second end portion 10b of the light-transmitting body 10 and the housing base 20. In the present example embodiment, the actuator 30 is located on the second end portion 10b side of the light-transmitting body 10.

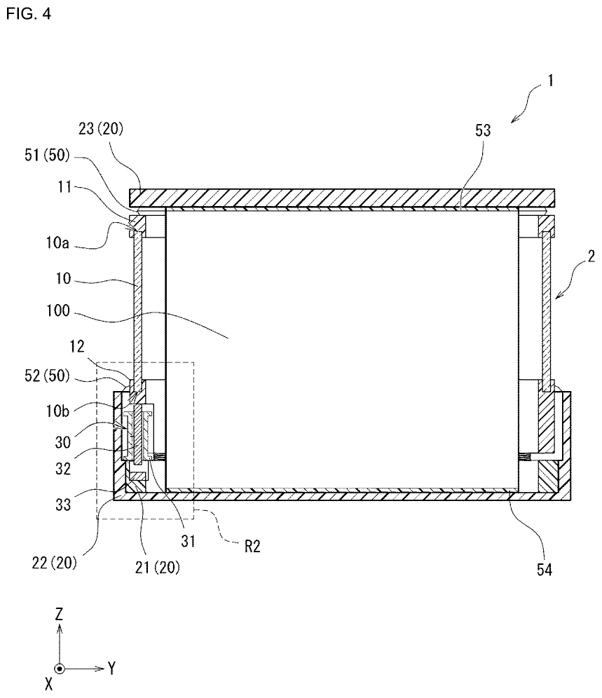

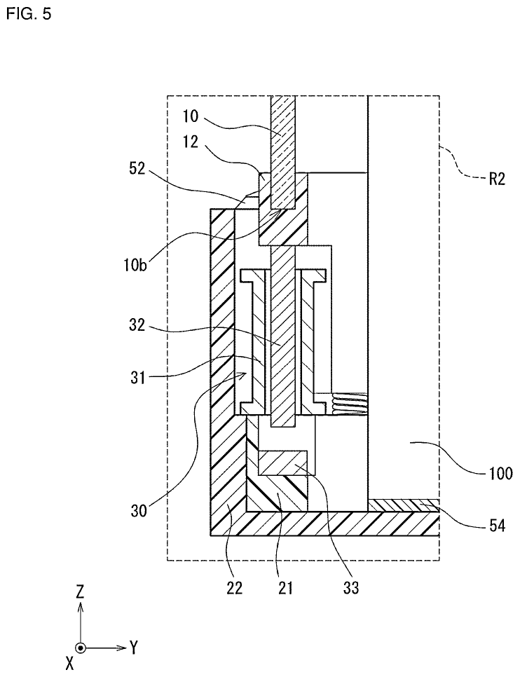

FIG. 4 is a sectional view taken along a line A-A of FIG. 1. FIG. 5 is an enlarged view of a region R2 of FIG. 4. As illustrated in FIGS. 4 and 5, the actuator 30 includes a coil 31, a core 32, and a magnet 33. The coil 31 generates a magnetic field when an electric current flows therethrough. The core 32 is inserted into the hollow of the coil 31 and supports the second end portion 10b of the light-transmitting body 10 via the holder 12. The magnet 33 is located on the second base 21 of the housing base 20 and attracts the core 32 due to a magnetic field generated by the coil 31. The actuator 30 vibrates the light-transmitting body 10 in the axial direction of the core 32. In the present example embodiment, the axial direction of the core 32 is the Z direction, and the actuator 30 vibrates the light-transmitting body 10 in the direction of an arrow A1 illustrated in FIG. 2.

In the present example embodiment, the core 32 is located on the second end portion 10b of the light-transmitting body 10 (the holder 12), and the coil 31 and the magnet 33 are located on the second base 21 of the housing base 20. Due to a magnetic field generated when an alternate current flows through the coil 31, a repulsive force and an attractive force are alternately generated, and the core 32 is pushed and pulled to be vibrated in the Z direction. That is, the core 32 vibrates in the Z direction. Due to the vibration in the Z direction generated by the actuator 30, the light-transmitting body 10 vibrates in the axial direction of the cylindrical shape (the Z direction). When the light-transmitting body 10 vibrates in the axial direction of the cylindrical shape, optical axis variation of the optical sensor 100 is unlikely to occur. Therefore, it is possible to improve detection accuracy even when the light-transmitting body is vibrating to remove foreign matter.

For example, when the housing 2 is disposed with the Z direction as the up-down direction, the light-transmitting body 10 vibrates upward and downward. In this case, it is possible to efficiently remove foreign matter such as waterdrops adhering to the light-transmitting body 10.

By providing the actuator 30 on the housing base 20, it is possible to vibrate the light-transmitting body 10 independently from the optical sensor 100. Therefore, vibration of the light-transmitting body 10 is unlikely to be transmitted to the housing base 20 and the optical sensor 100. Accordingly, even when the light-transmitting body 10 is vibrated by the actuator, the optical sensor 100 does not vibrate. That is, vibration of the light-transmitting body 10 is not transmitted to the optical sensor 100. Since vibration is not transmitted to the optical sensor 100, it is possible to suppress blur of a sensor image.

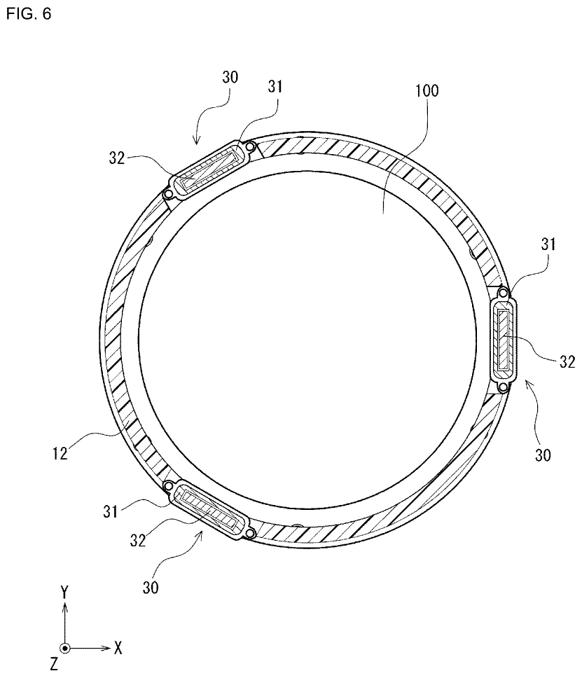

FIG. 6 is a sectional view taken along a line B-B of FIG. 2. In the present example embodiment, as illustrated in FIG. 6, three actuators 30 are arranged at regular intervals when seen from the axial direction (the Z direction) of the light-transmitting body 10 having a cylindrical shape. When the light-transmitting body 10 has a cylindrical or substantially cylindrical shape, a plurality of actuators 30 may be arranged at regular intervals on at least one of the first end portion 10a and the second end portion 10b of the light-transmitting body 10. In this case, it is possible to vibrate the light-transmitting body 10 in such a way as not to cause optical axis variation of the optical sensor 100.

### Elastic Body

In the present example embodiment, the housing base 20 includes an elastic body (spring) 40. To be specific, as illustrated in FIG. 3, on the second base 21 of the housing base 20, a spring is preferably provided as the elastic body 40 that absorbs vibration of the light-transmitting body 10. Due to the elastic body 40, it is possible to control an attractive bias force by adjusting a gap. The attractive bias force is a force with which the core 32 is attracted by the magnet 33 and is a force that repels a magnetic force so that the magnet 33 and the core 32 do not contact. Since the elastic body 40 is provided, it is possible to generate the attractive bias force, and it is possible to adjust the attractive bias force by adjusting the spring performance of the elastic body 40 or the gap length. With the elastic body 40, it is possible to suppress breakage of the light-transmitting body 10 due to collision with the housing base 20. The elastic body 40 is not limited to a spring, as long as the elastic body 40 is a member that can absorb vibration of the light-transmitting body 10.

### Cushioning Portion

A cushioning portion 50 is preferably located between the light-transmitting body 10 and the housing base 20. In the present example embodiment, the cushioning portion 50 is made of, for example, an elastomer and includes two cushioning portions 51 and 52. To be specific, as illustrated in FIG. 2, the cushioning portion 51 is disposed between the first end portion 10a (the holder 11) of the light-transmitting body 10 and the first base 23 of the housing base 20. The cushioning portion 52 is disposed between the second end portion 10b (the holder 12) of the light-transmitting body 10 and the body 22 of the housing base 20.

The cushioning portions 51 and 52 each preferably have a ring shape. It is possible to prevent entry of foreign matter to the inside of the housing 2 through the gap between the housing base 20 and the light-transmitting body 10. Moreover, since vibration of the light-transmitting body 10 becomes unlikely to be transmitted to the housing base 20 and the optical sensor 100, it is possible to prevent a sensor image from becoming unclear.

Moreover, in the present example embodiment, as illustrated in FIG. 4, vibration dampers 53 and 54 are provided between the optical sensor 100 and the housing base 20. Since the vibration dampers 53 and 54 are provided, vibration becomes more unlikely to be transmitted to the optical sensor 100, and it is possible to obtain a clear sensor image.

The housing 2 and the sensor device 1 according to the first example embodiment can provide the following advantageous effects.

The sensor device 1 includes the housing 2 and the optical sensor 100 provided inside of the housing 2. The housing 2 is a housing to contain the optical sensor 100. The housing 2 preferably includes the light-transmitting body 10, the housing base 20, and the actuator 30. The housing base 20 includes the optical sensor 100 and holds the light-transmitting body 10 to allow the light-transmitting body 10 to vibrate. The actuator 30 vibrates the light-transmitting body 10. With such a configuration, since vibration of the light-transmitting body 10 due to the actuator 30 is unlikely to be transmitted to the optical sensor 100, it is possible to provide a sensor device that can improve detection accuracy.

The actuator 30 includes the coil 31, the core 32, and the magnet 33, and vibrates the light-transmitting body in the axial direction of the core 32. The coil 31 generates a magnetic field when an electric current flows therethrough. The core 32 is inserted into the hollow of the coil 31 and supports the light-transmitting body 10. The magnet 33 attracts and repels the core 32 due to the magnetic field generated by the coil 31. The actuator 30 vibrates the light-transmitting body 10 in the axial direction of the core 32.

With such a configuration, it is possible to provide the housing 2 having a configuration that can vibrate the light-transmitting body 10 by using the actuator 30 and that is unlikely to transmit vibration of the light-transmitting body 10 to the housing base 20 and the optical sensor 100. Therefore, it is possible to improve the detection accuracy by reducing or preventing blur of a sensor image of the optical sensor 100.

The light-transmitting body 10 has a cylindrical or substantially cylindrical shape including the first end portion 10a and the second end portion 10b opposite to the first end portion 10a. The plurality of actuators 30 are arranged at regular intervals on at least one of the first end portion 10a side and the second end portion 10b side. With such a configuration, it is possible to use the housing 2 for the optical sensor 100 having a wide angle of view.

The plurality of actuators 30 vibrate the light-transmitting body 10 in the axial direction of the cylindrical shape. With such a configuration, since it is possible to vibrate the light-transmitting body 10 without causing optical axis variation of the optical sensor 100, it is possible to obtain a clear image.

The housing base 20 includes the elastic body 40 that absorbs vibration of the light-transmitting body 10. With such a configuration, it is possible to absorb vibration of the light-transmitting body 10 by using the elastic body (spring) 40. Therefore, vibration becomes unlikely to be transmitted to the optical sensor 100, and it is possible to reduce or prevent blur of a sensor image.

The cushioning portion 50 is located between the light-transmitting body 10 and the housing base 20. The cushioning portion 50 is made of, for example, an elastomer. With such a configuration, it is possible to reduce or prevent entry of dirt or foreign matter to the inside of the housing 2 or to the inside of the optical sensor 100.

In the example embodiment described above, an example in which the light-transmitting body 10 is held by the holders 11 and 12 has been described. However, the light-transmitting body 10 need not be held by the holders 11 and 12. For example, the actuator 30 may alternatively be disposed directly on the second end portion 10b of the light-transmitting body 10. The housing base 20 may be directly connected to the first end portion 10a of the light-transmitting body 10.

In the example embodiment described above, an example in which three actuators 30 are located on the second end portion 10b of the light-transmitting body 10 has been described. However, this is not a limitation. For example, the actuator 30 may be located on the first end portion 10a of the light-transmitting body 10. Alternatively, the actuator 30 may be located on each of the first end portion 10a and the second end portion 10b of the light-transmitting body 10. That is, the actuator 30 may be located on at least one of the first end portion 10a and the second end portion 10b of the light-transmitting body 10.

In the example embodiment described above, an example in which the housing 2 includes three actuators has been described. However, the number of actuators 30 is not limited to this. When the light-transmitting body 10 has a cylindrical shape, it is sufficient that the housing 2 include two or more actuators 30.

In the example embodiment described above, an example in which the housing base 20 is composed of a plurality of components has been described. However, the housing base 20 may be integrally formed.

### Modifications

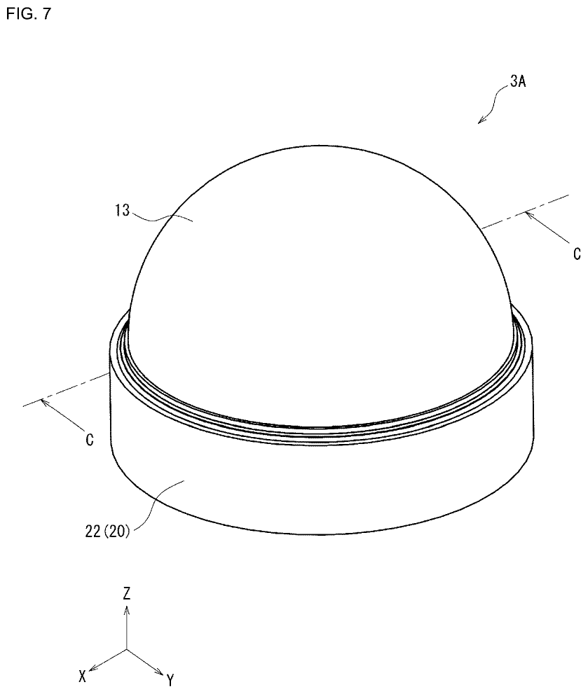

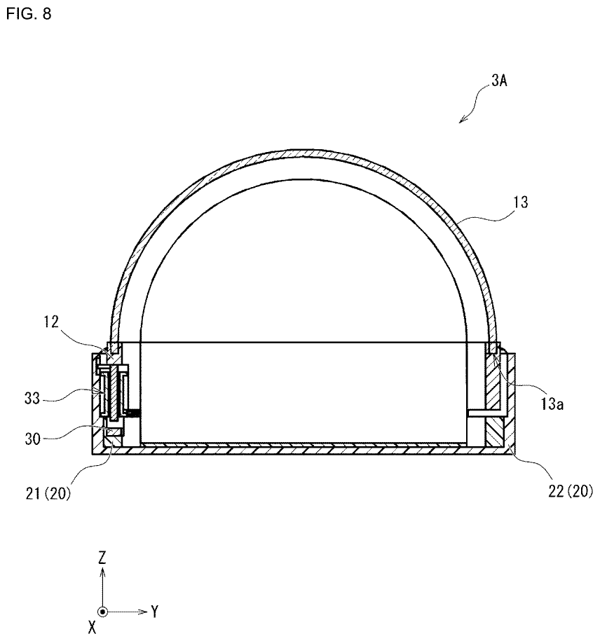

FIG. 7 is a perspective view illustrating a housing 3A according to a first modification of the first example embodiment. FIG. 8 is a sectional view taken along a line C-C of FIG. 7. As illustrated in FIGS. 7 and 8, a light-transmitting body 13 may have a dome shape. The “dome shape” means, for example, a shape such that a plate-shaped portion is curved in a hemispherical shape. In this case, the housing base 20 (the second base 21) is attached to an end portion 13a of the light-transmitting body 13 via the holder 12. When the light-transmitting body 13 has a dome shape, it is possible to further widen the field of view of the sensor.

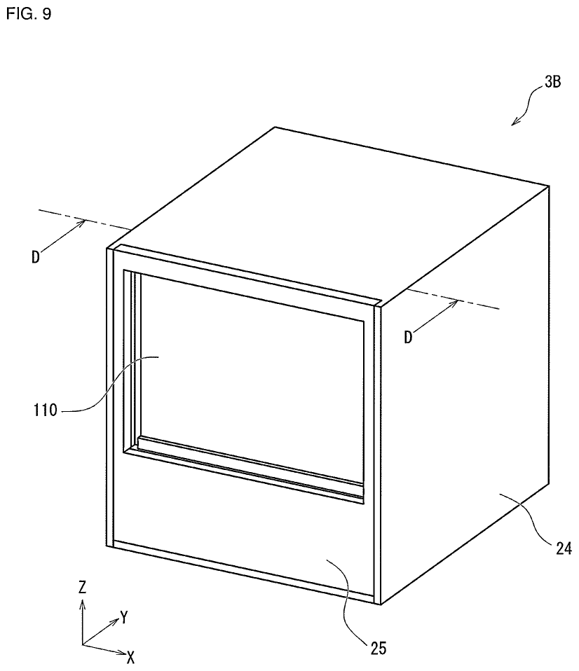

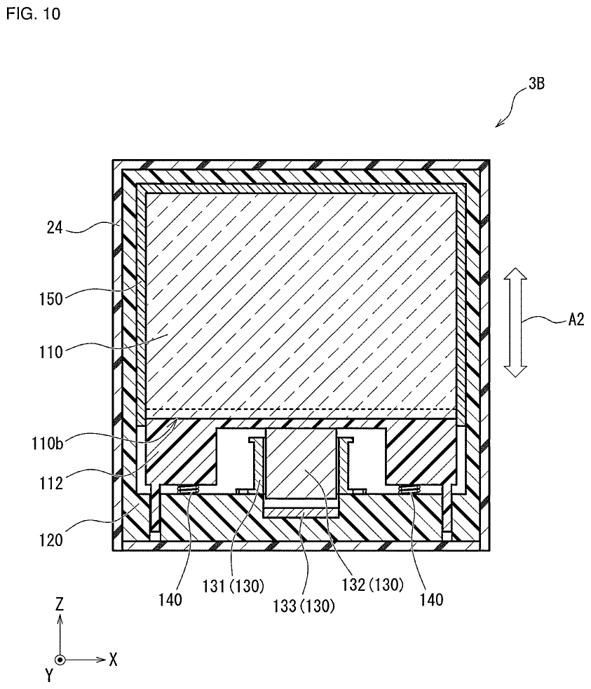

FIG. 9 is a perspective view illustrating a housing 3B according to a second modification of the first example embodiment. FIG. 10 is a sectional view taken along a line D-D of FIG. 9. As illustrated in FIGS. 9 and 10, the housing 3B preferably has, for example, a rectangular or substantially rectangular parallelepiped appearance and includes a plate-shaped light-transmitting body 110 disposed in one surface of a rectangular or substantially rectangular parallelepiped. As illustrated in FIG. 9, the housing 3B includes a housing base 24 having a rectangular or substantially rectangular parallelepiped shape. A housing cover 25 is located to oppose the light-transmitting body 110. As in the first example embodiment, a second end portion 110b of the light-transmitting body 110 is held by a holder 112. An actuator 130 is located on the second end portion 110b side of the light-transmitting body 110. A cushioning portion 150 is preferably surrounds the outer edge of the light-transmitting body 110. As in the first example embodiment, the actuator 130 preferably includes a coil 131, a core 132, and a magnet 133. A housing base 120 includes an elastic body 140 that absorbs vibration of the light-transmitting body 110.

In the housing 3B, the actuator 130 vibrates the light-transmitting body 110 in a direction that intersects the thickness direction of the light-transmitting body 110, that is, the direction of an arrow A2.

When the light-transmitting body 110 has a plate shape, the housing 3B may have a configuration including one actuator 130 as illustrated in FIG. 10, or may have a configuration including two or more actuators 130.

The housing 3B can be used, for example, for an optical sensor that performs sensing in a predetermined direction, such as the forward direction or the backward direction of an automobile.

### Second Example Embodiment

A housing according to a second example embodiment of the present invention will be described. In the second example embodiment, mainly differences from the first example embodiment will be described. In the description of the second example embodiment, elements that are the same as or equivalent to those of the first example embodiment will be denoted by the same numerals. In the second example embodiment, descriptions overlapping those of the first example embodiment will be omitted.

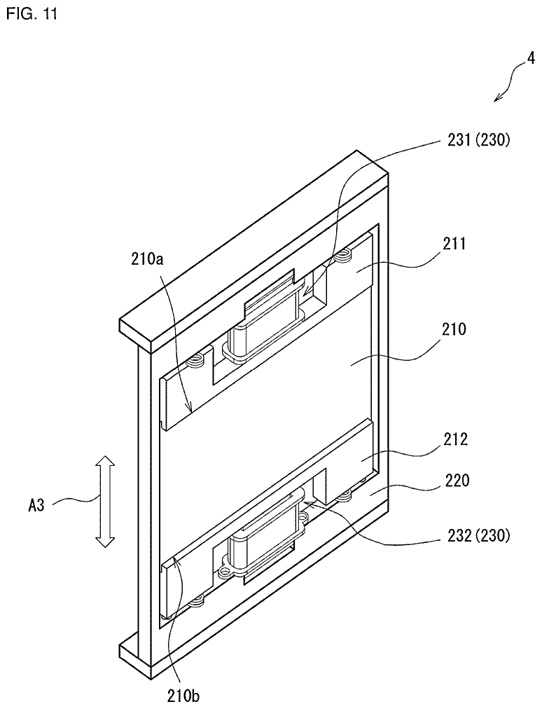

FIG. 11 is a perspective view illustrating a portion of a housing 4 according to the second example embodiment. As illustrated in FIG. 11, the second example embodiment differs from the first example embodiment in that actuators 230 are located on both of one end portion 210a side of a light-transmitting body 210 and the other end portion 210b side of the light-transmitting body 210.

In the present example embodiment, the light-transmitting body 210 has a plate shape. A holder 211 is located on the one end portion 210a of the light-transmitting body 210, and a holder 212 is located on the other end portion 210b of the light-transmitting body 210. The light-transmitting body 210 is disposed inside of a housing base 220 having a frame shape.

The actuators 230 include a first actuator 231 and a second actuator 232. The first actuator 231 is located on the one end portion 210a side of the light-transmitting body 210, and the second actuator 232 is located on the other end portion 210b side of the light-transmitting body 210 opposite to the first actuator 231. By disposing the first actuator 231 and the second actuator 232 in this way, it is possible to efficiently vibrate the light-transmitting body 210 in a direction that intersects the thickness direction of the light-transmitting body 210 (the direction of an arrow A3 in FIG. 11).

When the light-transmitting body 210 is to be vibrated by the first actuator 231 and the second actuator 232, the two actuators 231 and 232 may be located to oppose each other. In this case, the direction of vibration becomes unlikely to deviate from the direction of the arrow A3, and it is possible to more efficiently remove foreign matter on the light-transmitting body 210.

The housing 4 according to the second example embodiment can provide the following advantageous effects.

In the housing 4, the light-transmitting body 210 has a plate shape. The plurality of actuators 230 include the first actuator 231 and the second actuator 232. The first actuator 231 is located on the one end portion 210a side of the light-transmitting body 210. The second actuator 232 is located on the other end portion 210b of the light-transmitting body 210 opposite to the first actuator 231. With such a configuration, it is possible to efficiently vibrate the light-transmitting body.

The first actuator 231 and the second actuator 232 are disposed to oppose each other. With such a configuration, displacement of the vibration direction is unlikely to occur, and it is possible to more efficiently remove foreign matter on the light-transmitting body 210. Note that the first actuator 231 and the second actuator 232 need not oppose each other.

### Third Example Embodiment

A housing according to a third example embodiment of the present invention will be described. In the third example embodiment, mainly differences from the second example embodiment will be described. In the description of the third example embodiment, elements that are the same as or equivalent to those of the second example embodiment will be denoted by the same numerals. In the third example embodiment, descriptions overlapping those of the second example embodiment will be omitted.

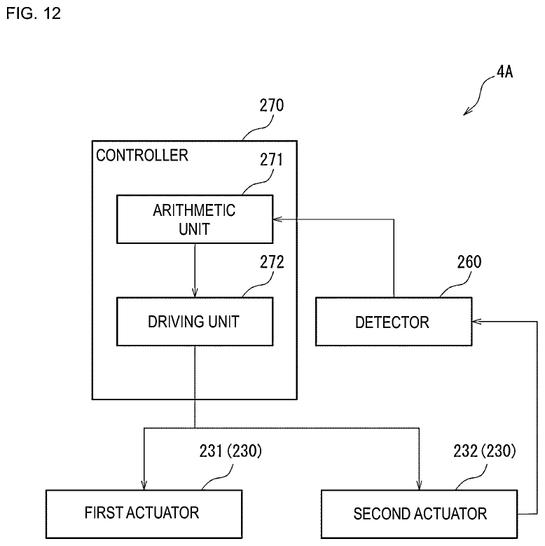

FIG. 12 is a block diagram illustrating the configuration of a housing 4A according to the third example embodiment. The third example embodiment differs from the second example embodiment in that the third example embodiment includes a detector 260 that detects the output voltage of the second actuator 232. Moreover, the third example embodiment differs from the second example embodiment in that the third example embodiment includes a controller 270 to control vibration of the actuator 230.

In the present example embodiment, as illustrated in FIG. 12, the detector 260 is connected to the second actuator 232. The detector 260 detects the output voltage of the second actuator 232.

Information about the output voltage detected by the detector 260 is sent to the controller 270. The controller 270, which controls the vibration of the actuator 230, is electrically connected to the detector 260, the first actuator 231, and the second actuator 232 in the present example embodiment.

In the present example embodiment, the controller 270 preferably includes an arithmetic unit 271 and a driver 272. The arithmetic unit 271 receives information about the output voltage of the second actuator 232 from the detector 260, and computes the amplitude of vibration of the light-transmitting body 210 based on the information. Based on the amplitude of vibration of the light-transmitting body 210, the driver 272 causes the first actuator 231 and the second actuator 232 to vibrate appropriately. For example, if vibration of the light-transmitting body 210 is smaller than a predetermined threshold, the driver 272 can provide at least one of the first actuator 231 and the second actuator 232 with vibration having the same phase, and conversely, if vibration of the light-transmitting body 210 is larger than the predetermined threshold, the driver 272 can provide at least one of the first actuator 231 and the second actuator 232 with vibration having the opposite phase.

The controller 270 includes, for example, a digital circuit such as a microcomputer, a CPU, an MPU, a GPU, a DSP, an FPGA, an ASIC, or the like. The controller 270 may further include a storage.

In this case, for example, the first actuator 231 may be used to vibrate the light-transmitting body 210, and the second actuator 232 may be used to detect vibration and to adjust acceleration or deceleration of vibration of the first actuator 231.

In this way, the controller controls vibration of the actuator 230 based on the output voltage of the actuator 230 detected by the detector 260.

The housing 4A according to the third example embodiment can provide the following advantageous effects.

The housing 4A further includes the detector 260 that detects the output voltage of the second actuator 232. With such a configuration, it is possible to detect the amplitude of vibration of the light-transmitting body 210 and to adjust the amplitude of vibration to an appropriate amplitude.

The housing 4A further includes the controller 270 that controls vibrations of one or a plurality of actuators 230. The controller 270 controls vibrations of the plurality of actuators 231 and 232 based on the output voltage of at least one of the actuators detected by the detector 260. With such a configuration, it is possible to realize sharp acceleration and deceleration of vibration.

In the example embodiment described above, an example in which the detector 260 is connected to the second actuator 232 has been described. However, it is sufficient that the detector 260 can detect the output voltage of at least one of the plurality of actuators 230. That is, it is sufficient that the detector 260 can detect the output voltage of at least one of the first actuator 231 and the second actuator 232.

### Fourth Example Embodiment

A housing according to a fourth example embodiment of the present invention will be described. In the fourth example embodiment, mainly differences from the second example embodiment will be described. In the description of the fourth example embodiment, elements that are the same as or equivalent to those of the second example embodiment will be denoted by the same numerals. In the fourth example embodiment, descriptions overlapping those of the second example embodiment will be omitted.

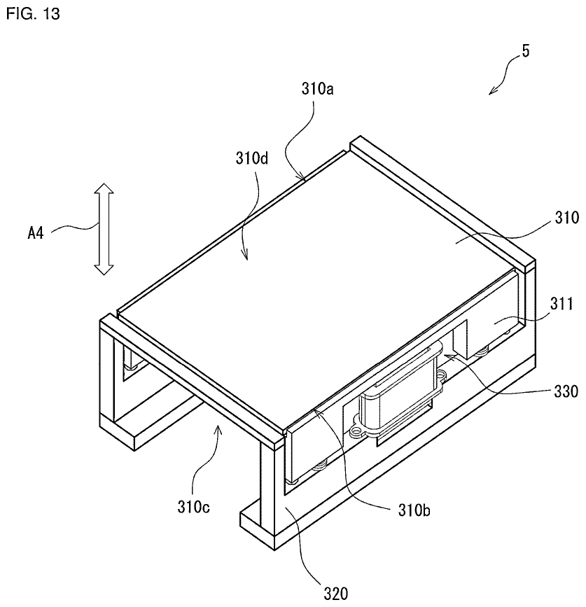

FIG. 13 is a perspective view illustrating a housing 5 according to the fourth example embodiment. The fourth example embodiment differs from the second example embodiment in that a light-transmitting body 310 has a plate shape having a first main surface 310d positioned outside and a second main surface 310c opposite to the first main surface 310d. Moreover, the fourth example embodiment preferably differs from the second example embodiment in that a plurality of actuators 330 are located on the second main surface 310c side of the light-transmitting body 310. Furthermore, the fourth example embodiment differs from the second example embodiment in that the plurality of actuators 330 vibrate the light-transmitting body 310 in the thickness direction of the light-transmitting body 310.

In the present example embodiment, the light-transmitting body 310 is located on a housing base 320 having a bent-frame shape. On an end portion of the light-transmitting body 310, a holder 311 that extends in a direction intersecting the second main surface 310c of the light-transmitting body 310 is provided.

Two actuators 330 are located on the second main surface 310c side of the light-transmitting body 310. The two actuators 330 vibrate the light-transmitting body 310 in the thickness direction of the light-transmitting body 310 (the direction of an arrow A4). The two actuators 330 are respectively disposed along one end portion 310a and the other end portion 310b, opposite the one end portion 310a, of the light-transmitting body 310. In this case, it is possible to remove foreign matter by vibrating the light-transmitting body 310 without obstructing the field of view of the optical sensor. More preferably, the two actuators 330 may be disposed to oppose each other. In this case, it is possible to efficiently vibrate the light-transmitting body 310.

The housing 5 according to the fourth example embodiment can provide the following advantageous effects.

In the housing 5, the light-transmitting body 310 has a plate shape having the first main surface 310d positioned outside and the second main surface 310c opposite to the first main surface 310d. The plurality of actuators 330 are located on the second main surface 310c side of the light-transmitting body 310. With such a configuration, since the actuators 330 is unlikely to be seen from the front of the light-transmitting body 310, it is possible to reduce the height and improve the design of the sensor device. For example, in a case where a sensor device is to be set above the windshield of an automobile, the sensor device is required to have low air resistance. The housing 5 is effective in such a case, because the housing 5 can have lower air resistance due to reduced height.

The plurality of actuators 330 vibrate the light-transmitting body 310 in the thickness direction of the light-transmitting body 310. With such a configuration, it is possible to make foreign matter adhering to the light-transmitting body 310 easier to be removed by deforming the foreign matter by vibration.

### Fifth Example Embodiment

A housing according to a fifth example embodiment of the present invention will be described. In the fifth example embodiment, mainly differences from the first example embodiment will be described. In the description of the fifth example embodiment, elements that are the same as or equivalent to those of the first example embodiment will be denoted by the same numerals. In the fifth example embodiment, descriptions overlapping those of the first example embodiment will be omitted.

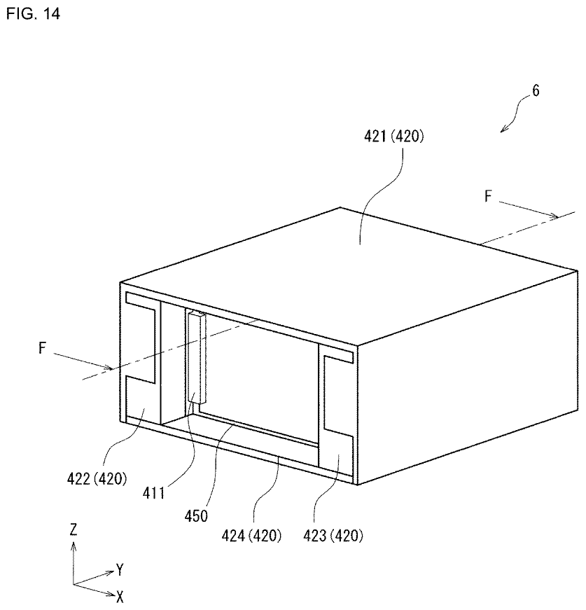

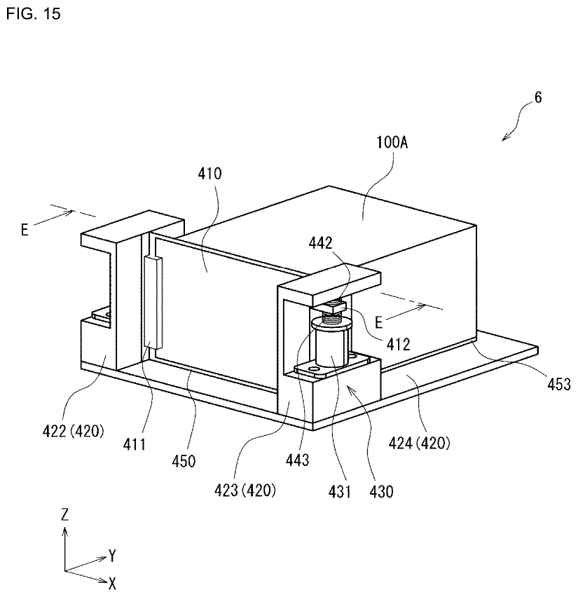

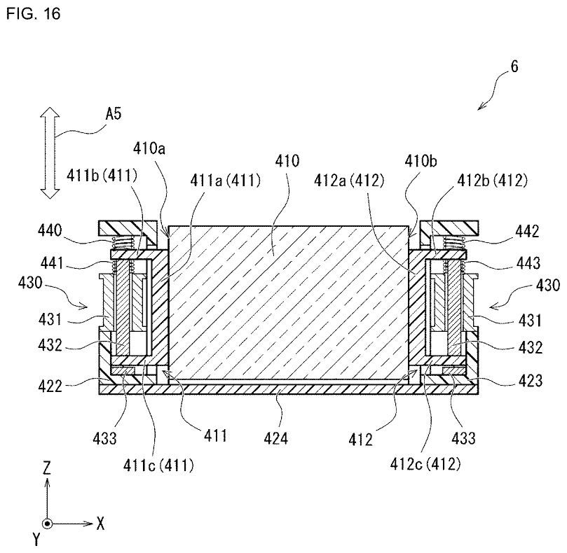

FIG. 14 is a perspective view of a housing 6 according to the fifth example embodiment. FIG. 15 is a perspective view of the housing 6 of FIG. 14 a part of which is omitted. FIG. 16 is a sectional view taken along a line E-E of FIG. 15. The fifth example embodiment differs from the first example embodiment in the shape of a light-transmitting body 410 and the position and the shape of an actuator 430.

In the present example embodiment, as illustrated in FIG. 14, a housing base 420 has a box shape and includes a bottom portion 424, an upper portion 421, and coil-supporting portions 422 and 423.

In the present example embodiment, as illustrated in FIGS. 15 and 16, the light-transmitting body 410 is a plate-shaped portion having a rectangular or substantially rectangular shape. The light-transmitting body 410 is interposed between the coil-supporting portions 422 and 423 of the housing base 420. A holder 411 is disposed at one end 410a of the light-transmitting body 410, and a holder 412 is disposed at the other end 410b opposite to the one end 410a.

As illustrated in FIG. 16, the holder 411 has a shape including a body 411a and core-supporting portions 411b and 411c respectively protruding from two ends of the body 411a. The body 411a supports the one end 410a of the light-transmitting body 410, and the core-supporting portions 411b and 411c support a core 432 (described below) therebetween. Similarly, the holder 412 has a shape including a body 412a and the core-supporting portions 412b and 412c respectively protruding from two ends of the body 412a. The body 412a supports the other end 410b of the light-transmitting body 410, and the core-supporting portions 412b and 412c support a core 432 therebetween.

The actuator 430 is located on each of the coil-supporting portions 422 and 423 of the housing base 420. The actuator 430 includes a coil 431, the core 432, and a magnet 433. When the coil 431 generates a magnetic field, a repulsive force against the magnet 433 and an attractive force toward the magnet 433 are alternately generated, and the core 432 vibrates upward and downward in the Z direction. Therefore, it is possible to vibrate the light-transmitting body 410 in the Z direction. In this way, in the present example embodiment, the light-transmitting body 410 vibrates in the Z direction (the direction of an arrow A5 in FIG. 16), and two actuators 430 are disposed with the light-transmitting body 410 therebetween in the X direction. By arranging the two actuators 430 in a direction that intersects the vibration direction, it becomes possible to reduce the height of the sensor device.

In the present example embodiment, an elastic body (spring) 440 is located on the coil-supporting portion 422 of the housing base 420. Moreover, an elastic body 441 is preferably also located on the core 432, and the two elastic bodies 440 and 441 hold the core-supporting portion 411b of the holder 411 therebetween. Similarly, an elastic body (spring) 442 is located on the coil-supporting portion 423 of the housing base 420, and an elastic body 443 is disposed also on the core 432. The two elastic bodies 442 and 443 hold the core-supporting portion 412b of the holder 412 therebetween. With such a configuration, it is possible to adjust a bias force to fix the light-transmitting body 410. The bias force is a force generated by the elastic bodies 440 and 441 and the elastic bodies 442 and 443 to repel a magnetic force so that the core 432 does not contact the magnet 432 by being attracted by the magnet 433. It is possible to adjust the bias force by the spring performance of the elastic bodies 440 to 443 or the gap length. Moreover, the elastic bodies 440 to 443 can generate a repulsive force for suppressing collision of the holders 411 and 412 and the light-transmitting body 410 with the housing base 420.

A cushioning portion 450 is located on the outer periphery of the light-transmitting body 410 (see FIG. 15). The cushioning portion 450 is made of, for example, an elastomer, and is disposed between the light-transmitting body 410 and the housing base 420. With such a configuration, it is possible to prevent collision of the light-transmitting body 410 with the housing base 420 due to vibration. Moreover, it is possible to prevent entry of foreign matter to the inside of the housing 6 from the outside.

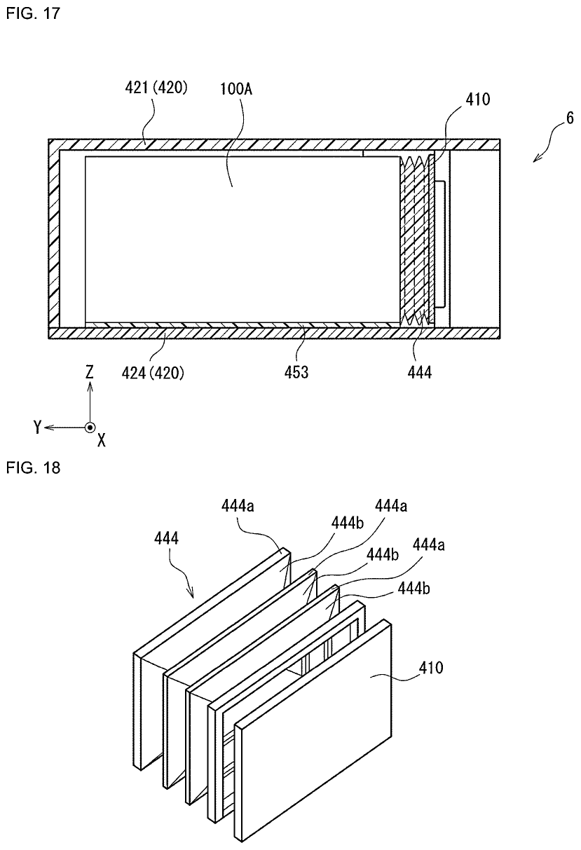

FIG. 17 is a sectional view taken along a line F-F of FIG. 14. FIG. 18 is a schematic view illustrating a cushioning portion 444 of FIG. 17. In the present example embodiment, as illustrated in FIG. 17, the cushioning portion 444 is located between the light-transmitting body 410 and an optical sensor 100A.

As illustrated in FIG. 18, the cushioning portion 444 preferably has a bellows structure. The bellows structure has a shape such that a plurality of protruding portions 444a and a plurality of recessed portions 444b are alternately and repeatedly arranged in the thickness direction of the light-transmitting body 410, and a protruding portion 444a and a recessed portion 444b that are adjacent to each other are coupled to be extendable and contactable. Since the cushioning portion 444 having the bellows structure is provided, it is possible to absorb vibration of the light-transmitting body 410 by using the cushioning portion 444. Moreover, since the cushioning portion 444 is between the light-transmitting body 410 and the optical sensor 100A, it is possible to prevent entry of foreign matter into a gap between the optical sensor 100A and the light-transmitting body 410.

As illustrated in FIGS. 15 and 17, a vibration damper 453 is located between the optical sensor 100A and the bottom portion 424 of the housing base 420. Since the vibration damper 453 is provided, vibration becomes more unlikely to be transmitted to the optical sensor 100A, and it is possible to improve detection accuracy.

The housing 6 according to the fifth example embodiment can provide the following advantageous effects.

By arranging the two actuators 430 in a direction that intersects the vibration direction, it becomes possible to reduce the height of the sensor device.

The cushioning portion 444 having a bellows structure is disposed between the light-transmitting body 410 and the optical sensor 100A. With such a configuration, it is possible to prevent entry of foreign matter into a gap between the optical sensor 100A and the light-transmitting body 410 without affecting a sensor image to be captured by the optical sensor 100A.

### Sixth Example Embodiment

A housing according to a sixth example embodiment of the present invention will be described. In the sixth example embodiment, mainly differences from the first example embodiment will be described. In the description of the sixth example embodiment, elements that are the same as or equivalent to those of the first example embodiment will be denoted by the same numerals. In the sixth example embodiment, descriptions overlapping those of the first example embodiment will be omitted.

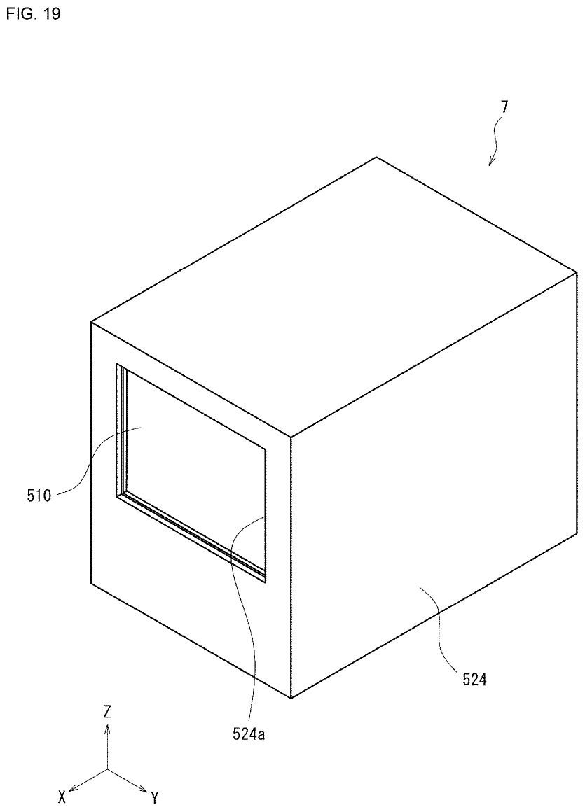

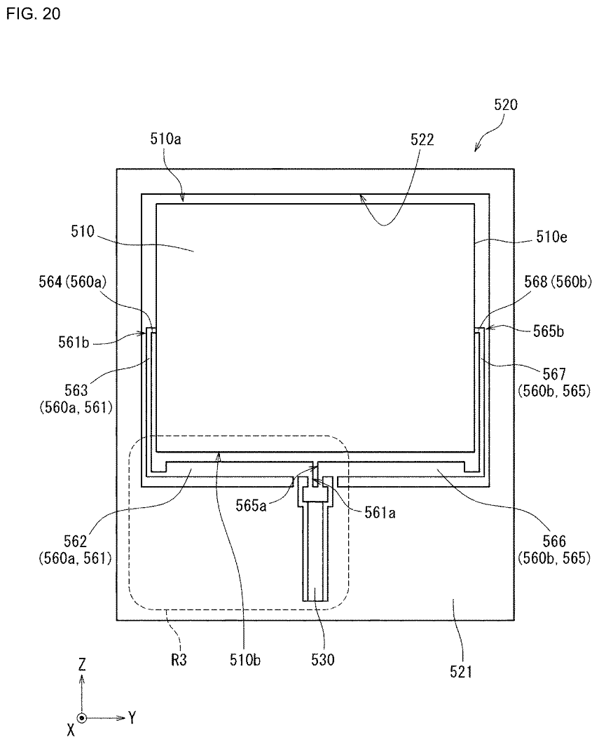

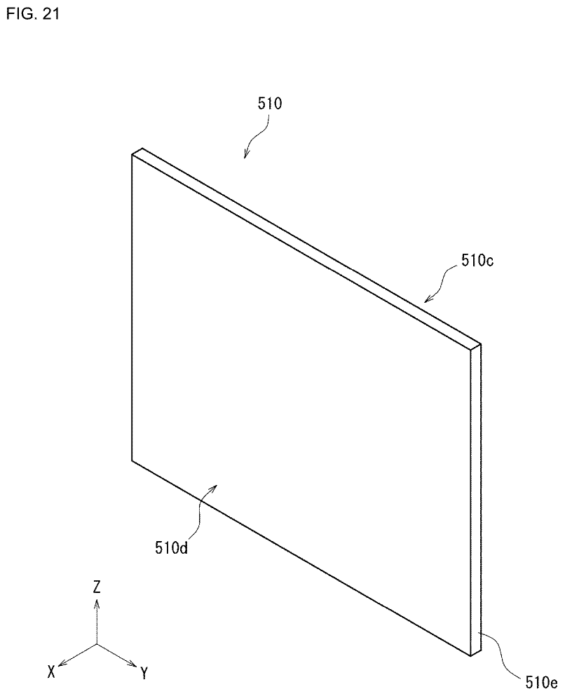

FIG. 19 is a perspective view illustrating a housing 7 according to the sixth example embodiment. FIG. 20 is a front view illustrating a housing base 520 of the housing 7 of FIG. 19. FIG. 21 is a perspective view illustrating a light-transmitting body 510 of the housing 7 of FIG. 19. As illustrated in FIGS. 19 and 20, the sixth example embodiment preferably differs from the first example embodiment in that an actuator 530 includes a piezoelectric element and the housing base 520 includes vibration-transmitting portions 560a and 560b. Moreover, the sixth example embodiment differs from the first example embodiment in that the light-transmitting body 510 has a plate shape. Furthermore, the sixth example embodiment differs from the first example embodiment in that the housing 7 has a rectangular or substantially rectangular parallelepiped appearance.

In the present example embodiment, the housing 7 has a rectangular or substantially rectangular parallelepiped appearance and includes a housing base 524 having a rectangular or substantially rectangular parallelepiped shape as illustrated in FIG. 19. The housing base 520 (see FIG. 20), to which the light-transmitting body 510 is attached, is included in the housing base 524. The light-transmitting body 510 attached to the housing base 520 is exposed to the outside through an opening 524a of the housing base 524.

In the present example embodiment, as illustrated in FIG. 21, the light-transmitting body 510 preferably has a plate shape including a first main surface 510d positioned outside, a second main surface 510c opposite to the first main surface 510d, and a side surface 510e connecting the first main surface 510d and a second main surface 510c. In the present example embodiment, the light-transmitting body 510 has a rectangular or substantially rectangular shape when seen from the first main surface 510d.

As illustrated in FIG. 20, the housing base 520 includes a vibration-transmitting portion that connects the actuator 530 and the light-transmitting body 510 and transmits vibration to the light-transmitting body 510. The vibration-transmitting portion includes a first vibration-transmitting portion 560a and a second vibration-transmitting portion 560b. In the present example embodiment, the housing base 520 includes a frame 521 that surrounds the light-transmitting body 510. An opening 522, in which the light-transmitting body 510 is disposed, is formed in the frame 521. Further, the first vibration-transmitting portion 560a and the second vibration-transmitting portion 560b are disposed along the opening 522.

The first vibration-transmitting portion 560a includes a vibration portion 561 and a support portion 564. To be specific, the vibration portion 561 includes one end portion 561a and the other end portion 561b, the one end portion 561a being connected to the actuator 530, and extends along the side surface 510e of the light-transmitting body 510. In the present example embodiment, the vibration portion 561 includes a first extending portion 562 connected to the actuator 530 and a second extending portion 563 that extends from the first extending portion 562 to be connected to the support portion 564. The support portion 564 extends from the other end portion 561b of the vibration portion 561 toward the side surface 510e of the light-transmitting body 510 and supports the side surface 510e of the light-transmitting body 510.

The second vibration-transmitting portion 560b includes a vibration portion 565 and a support portion 568. To be specific, the vibration portion 565 includes one end portion 565a and the other end portion 565b, the one end portion 565a being connected to the actuator 530, and extends along the side surface 510e of the light-transmitting body 510. In the present example embodiment, the vibration portion 565 includes a first extending portion 566 connected to the actuator 530 and a second extending portion 567 that extends from the first extending portion 566 to be connected to the support portion 568. The support portion 568 extends from the other end portion 565b of the vibration portion 565 toward the side surface 510e of the light-transmitting body 510 and supports the side surface 510e of the light-transmitting body 510.

By being made of, for example, a metal material, the first vibration-transmitting portion 560a and the second vibration-transmitting portion 560b can efficiently transmit the vibration of the actuator 530 to the light-transmitting body 510. The first vibration-transmitting portion 560a and the second vibration-transmitting portion 560b may be integrally formed with the housing base 520.

The first vibration-transmitting portion 560a and the second vibration-transmitting portion 560b have a bilaterally symmetric shape when seen from the first main surface 510d of the light-transmitting body 510. The first extending portion 562 of the first vibration-transmitting portion 560a and the first extending portion 566 of the second vibration-transmitting portion 560b are disposed to extend from the actuator 530 in opposite directions. The support portion 564 of the first vibration-transmitting portion 560a and the support portion 568 of the second vibration-transmitting portion 560b are disposed to oppose each other and support the side surface 510e of the light-transmitting body 510 therebetween. The support portions 564 and 568 are each disposed at the center of the side surface 510e of the light-transmitting body 510 in the Z direction.

The support portions 564 and 568 and the light-transmitting body 510 can be connected, for example, by inserting protrusions defined on the support portions 564 and 568 into holes defined in the light-transmitting body 510. Alternatively, the light-transmitting body 510 may be supported by the support portions 564 and 568 by attaching the support portions 564 and 568 to a frame that is attached to the first main surface 510d, the second main surface 510c, or the side surface 510e along the outer periphery of the light-transmitting body 510. In this case, the support portions 564 and 568 and a frame portion may be integrated. The support portions 564 and 568 can rotatably support the light-transmitting body 510.

In the present example embodiment, as illustrated in FIG. 20, in the frame 521 of the housing base 520, the actuator 530 is located on the second end portion 510b side of the light-transmitting body 510. The actuator 530 includes, for example, a piezoelectric element such as multilayer piezoelectric ceramics. In the housing 7, a conductor (not shown) for providing a potential to the piezoelectric element of the actuator 530 may be disposed.

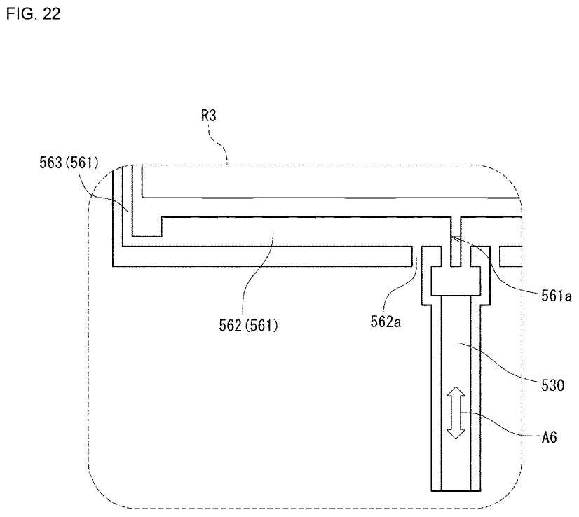

The actuator 530 vibrates in a first direction that intersects a direction (the Y direction) in which the support portions 564 and 568, respectively, of the first vibration-transmitting portion 560a and the second vibration-transmitting portion 560b oppose each other and in which the first main surface 510d of the light-transmitting body 510 extends. That is, the actuator 530 vibrates so as to reciprocate in the direction of an arrow A6 of FIG. 22 (the Z direction) described below.

FIG. 22 is an enlarged view of a region R3 of FIG. 20. Referring to FIG. 22, how the first vibration-transmitting portion 560a transmits vibration to the light-transmitting body 510 will be described.

The actuator 530 vibrates in the direction of the arrow A6. The vibration of the actuator 530 is transmitted from the one end portion 561a to the first extending portion 562, and the vibration of the actuator 530 is amplified by the first extending portion 562 while a connection portion 562a with the frame 521 functions as a fulcrum. The vibration amplified by the first extending portion 562 is transmitted to the light-transmitting body 510 via the second extending portion 563. Also regarding the second vibration-transmitting portion 560b, the vibration of the actuator 530 is amplified by the first extending portion 566 in the same way, and the vibration is transmitted to the light-transmitting body 510 via the second extending portion 567.

Since the first extending portions 562 and 566 are portions that amplify the vibration of the actuator 530, it is preferable that the first extending portions 562 and 566 have a high rigidity to a certain degree. In order to increase the rigidity of the vibration portion, the first extending portions 562 and 566 are formed to have a larger width than the second extending portions 563 and 567.

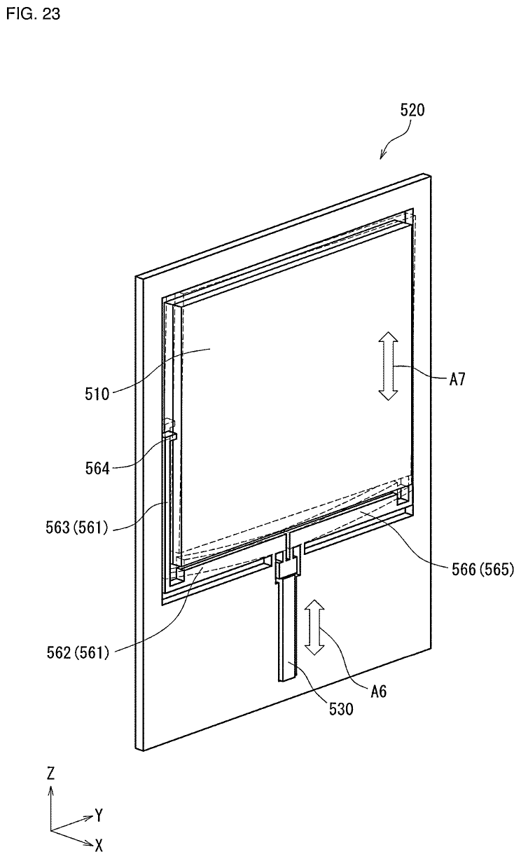

FIG. 23 illustrates an example of the vibration mode of the light-transmitting body 510. By applying a signal having a predetermined frequency to the actuator 530 by using a control device (not shown), it is possible to vibrate the light-transmitting body 510 in a direction that is the same as the vibration direction (the arrow A6) of the actuator 530 (slide mode). That is, as indicated by an arrow A7 of FIG. 23, it is possible to vibrate the light-transmitting body 510 in the Z direction. When the light-transmitting body 510 is vibrating in the slide mode, the first extending portions 562 and 566 of the vibration-transmitting portions 560a and 560b are flexurally vibrating in the Z direction. By vibrating the light-transmitting body 510 in the Z direction, it is possible to efficiently slide down foreign matter adhering to the light-transmitting body 510 in the gravitational direction (the downward direction along the Z axis).

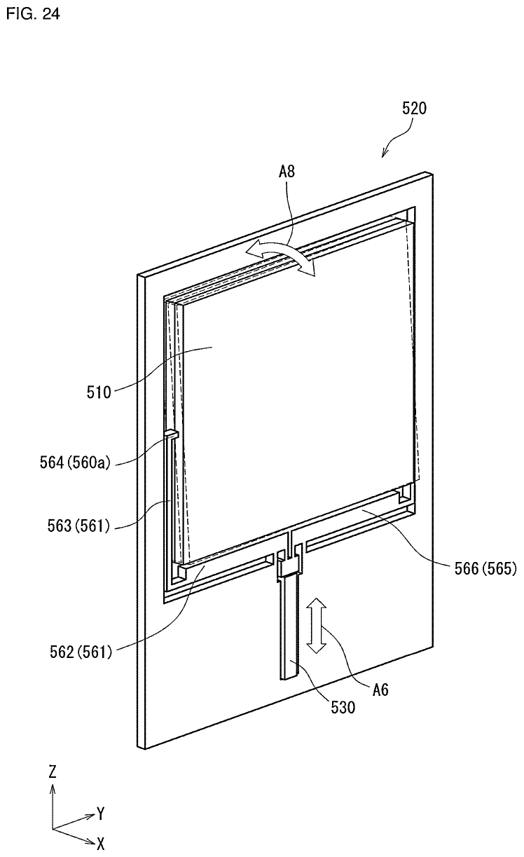

FIG. 24 illustrates another example of the vibration mode of the light-transmitting body 510. By changing the frequency of a signal applied to the actuator 530 by using the control device, it is possible to vibrate the light-transmitting body 510 in such a way that the light-transmitting body 510 rotates around the support portions 564 and 568, respectively, of the vibration-transmitting portions 560a and 560b (rotation mode) That is, as indicated by an arrow A8, it is possible to vibrate the light-transmitting body 510 in such a way that the light-transmitting body 510 rotates around a rotation axis extending in the Y direction. For example, it is possible to vibrate the light-transmitting body 510 in the rotation mode by applying a signal having a frequency lower than that in the slide mode to the actuator 530. As an example, a signal having a frequency of about 220 Hz can be used to vibrate the light-transmitting body 510 in the slide mode, and a signal having a frequency of about 160 Hz, which is lower than that in the slide mode, can be used to vibrate the light-transmitting body 510 in the rotation mode. It is possible to generate vibration in the rotation mode around the support portions 564 and 568 by using a natural frequency that is determined by the structures of the light-transmitting body 510, the vibration-transmitting portions 560a and 560b, and the like. It is possible to vibrate the light-transmitting body 510 in the rotation mode by applying vibration energy necessary to excite a natural frequency to the actuator 530. When the light-transmitting body 510 is vibrating in the rotation mode, the first extending portions 562 and 566 of the vibration-transmitting portions 560a and 560b vibrate due to the action of vibration of the light-transmitting body 510 in the rotation mode. By vibrating the light-transmitting body 510 in this way, it is possible to efficiently remove foreign matter adhering to the light-transmitting body in the thickness direction of the light-transmitting body 510 (the X direction).

The housing 7 according to the sixth example embodiment can provide the following advantageous effects.

By using a piezoelectric element as the actuator 530, it is possible to remove foreign matter by efficiently vibrating the light-transmitting body while reducing power consumption.

The support portions 564 and 568, respectively, of the first vibration-transmitting portion 560a and the second vibration-transmitting portion 560b are disposed at the center of the side surface 510e of the light-transmitting body 510 in the first direction (the Z direction). Therefore, by changing a frequency applied to the actuator 530, it is possible to vibrate the light-transmitting body 510 in two modes, which are the slide mode and the rotation mode.

In the example embodiment described above, an example in which the light-transmitting body 510 has a rectangular shape in a plan view has been described. However, the shape of the light-transmitting body 510 is not limited to this. As long as the light-transmitting body 510 has a plate shape, the light-transmitting body 510 may have any appropriate shape such as a circle, an ellipse, a polygon, and the like.

### Modification

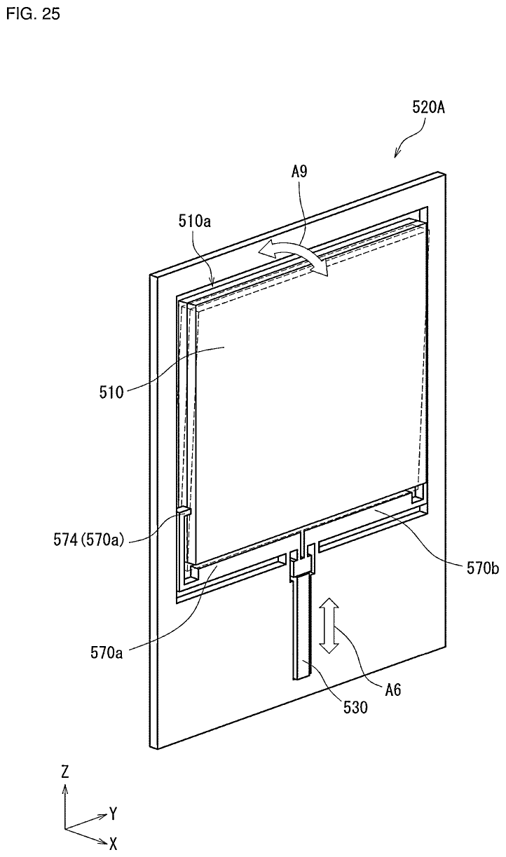

FIG. 25 illustrates an example of the vibration mode of the light-transmitting body 510 in a housing base 520A according to a modification of the sixth example embodiment.

As illustrated in FIG. 25, in the housing base 520A, support portions 574, respectively, of a first vibration-transmitting portion 570a and a second vibration-transmitting portion 570b are located at positions closer to the actuator 530 than to the center in the first direction (the Z direction). That is, the light-transmitting body 510 is supported at a position below the center in the Z direction. In this case, when the light-transmitting body 510 is vibrated in the rotation mode as indicated by an arrow A9, vibrational displacement of the first end portion 510a side of the light-transmitting body 510 becomes large. Therefore, it is possible to slide down foreign matter adhering to the upper side of the light-transmitting body 510 while sweeping away foreign matter adhering to the lower side.

### Seventh Example Embodiment

A housing according to a seventh example embodiment of the present invention will be described. In the seventh example embodiment, mainly differences from the sixth example embodiment will be described. In the description of the seventh example embodiment, elements that are the same as or equivalent to those of the sixth example embodiment will be denoted by the same numerals. In the seventh example embodiment, descriptions overlapping those of the sixth example embodiment will be omitted.

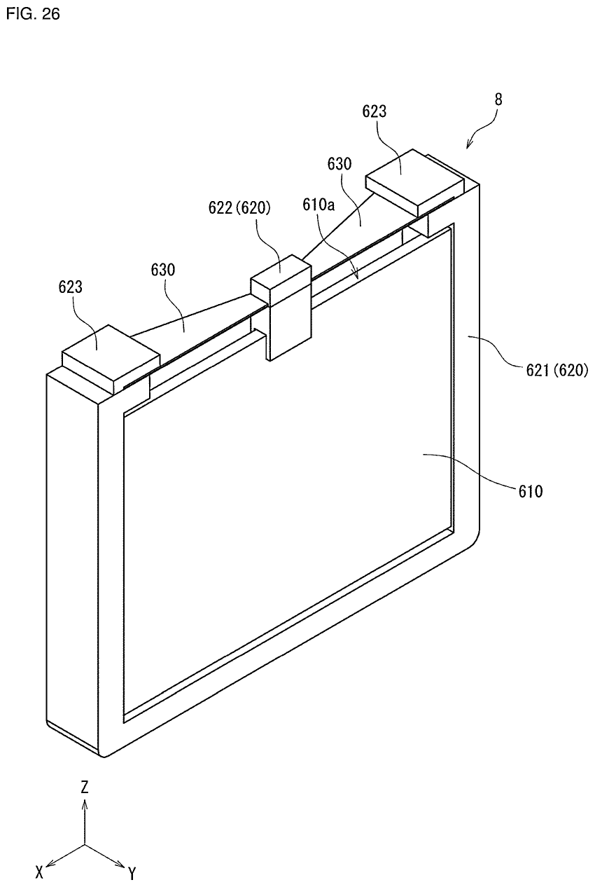

FIG. 26 is a perspective view illustrating a housing 8 according to the seventh example embodiment. The seventh example embodiment differs from the sixth example embodiment in that, as illustrated in FIG. 26, an actuator 630 includes a unimorph or bimorph piezoelectric element, and a housing base 620 includes a frame 621 and a connection portion 622.

The housing base 620 includes the frame 621 that supports a light-transmitting body 610 and the connection portion 622 that connects the light-transmitting body 610 and the actuator 630. In the present example embodiment, the light-transmitting body 610 has a plate shape, and the frame 621 is provided to surround a side surface of the light-transmitting body 610. The connection portion 622 holds the light-transmitting body 610 by gripping a first end portion 610a in the thickness direction.

In the present example embodiment, two actuators 630 are in the housing 8. The actuators 630 each include a unimorph or bimorph piezoelectric element. A unimorph piezoelectric element is an element in which, for example, a sheet-shaped piezoelectric element is affixed to a plate-shaped metal, and warpage occurs in the metal plate because the dimensions of the metal plate do not change while the piezoelectric element extends and contracts in the planar direction. A bimorph piezoelectric element is an element in which two sheet-shaped piezoelectric elements are affixed, and warpage occurs in each of the piezoelectric elements as the piezoelectric elements extend and contract in planar directions that are opposite to each other. In the present example embodiment, warpage occurs as the piezoelectric elements extend and contract in the X direction, and it is possible to vibrate the connection portion 622 in the Z direction.

One end of each of the two actuators 630 is fixed, for example, by a latch 623 provided on the frame 621, and the other end of each of the two actuators 630 is fixed by the connection portion 622. The connection portion 622 vibrates in the Z direction due to the actuators 630. As the connection portion vibrates, the light-transmitting body 610 also vibrates in the Z direction. In the present example embodiment, the actuators 630 are each formed so that the width thereof decreases from the latch 623 toward the connection portion 622. By decreasing the width toward the connection portion 622, warpage increases toward the connection portion 622, and thus it is possible to more efficiently vibrate the light-transmitting body 610.

### Advantageous Effects

The housing 8 according to the seventh example embodiment can provide the following advantageous effects.

It is possible to achieve cost reduction by using a unimorph or bimorph piezoelectric element for the actuator 630.

Moreover, the size of the housing can be reduced, because the dimension in the vertical direction (the Z direction) can be reduced compared with the sixth example embodiment.

### Eighth Example Embodiment

A housing according to an eighth example embodiment of the present invention will be described. In the eighth example embodiment, mainly differences from the sixth example embodiment will be described. In the description of the eighth example embodiment, elements that are the same as or equivalent to those of the sixth example embodiment will be denoted by the same numerals. In the eighth example embodiment, descriptions overlapping those of the sixth example embodiment will be omitted.

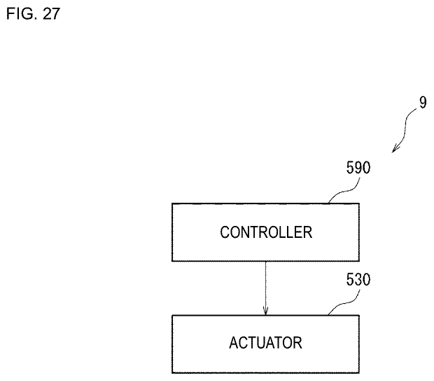

FIG. 27 is a block diagram illustrating the configuration of a housing 9 according to the eighth example embodiment. The eighth example embodiment preferably differs from the sixth example embodiment in that the housing 9 includes a controller 590 that controls the actuator 530. The other configurations of the housing 9 are the same as those of the housing 7 illustrated in FIGS. 19 to 22.

The controller 590 causes the actuator 530 to vibrate by applying a signal having a predetermined frequency to the actuator 530. The controller 590 preferably includes, for example, a digital circuit such as a microcomputer, a CPU, an MPU, a GPU, a DSP, an FPGA, an ASIC, or the like. The controller 590 may further include, for example, a storage device.

The controller 590 causes the actuator 530 to vibrate at a modulation frequency in which a first resonant frequency of the actuator 530 and a second resonant frequency of foreign matter adhering to the light-transmitting body 510 are superposed. In the present example embodiment, foreign matter adhering to the light-transmitting body 510 is liquid drops including rainwater, muddy water, and the like. By vibrating the foreign matter (liquid drops) with the second resonant frequency, deformation or movement of the liquid drops tend to occur, and thus it becomes easier to remove the liquid drops from the light-transmitting body 510.

It is possible to efficiently slide down foreign matter by vibrating the light-transmitting body 510 with a frequency close to the second resonant frequency of foreign matter adhering to the light-transmitting body 510. However, usually, the first resonant frequency of the actuator 530 and the second resonant frequency of the foreign matter are different. Thus, by causing the actuator to vibrate at a modulation frequency in which the first resonant frequency and the second resonant frequency are superposed, it is possible to promote deformation of foreign matter adhering to the light-transmitting body 510 and to efficiently slide down the foreign matter.

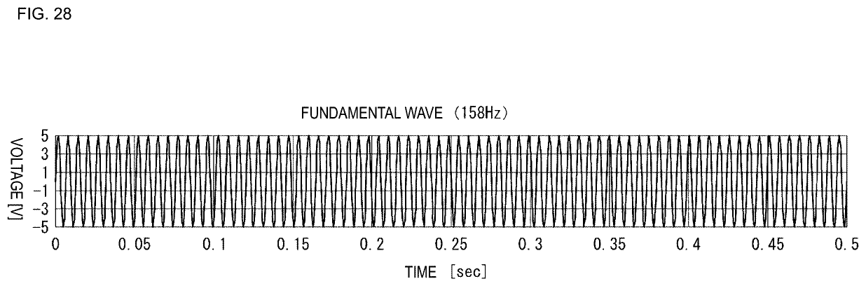

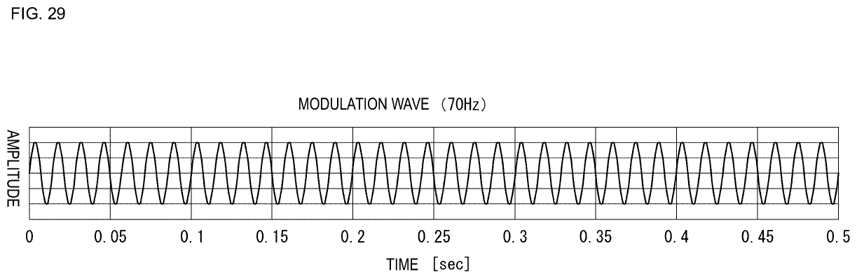

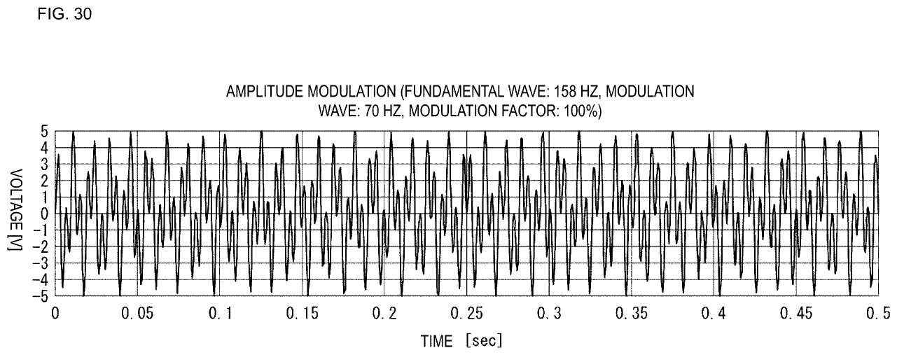

FIG. 28 is a graph illustrating an example of a signal having the first resonant frequency. FIG. 29 is a graph illustrating an example of a signal having the second resonant frequency. FIG. 30 is a graph illustrating an example of a signal having a resonant frequency in which the first resonant frequency and the second resonant frequency are superposed.

As illustrated in FIGS. 28 to 30, the first resonant frequency of the actuator 530 is 158 Hz, and the second resonant frequency of foreign matter is about 70 Hz. It is supposed that foreign matter in this case is liquid drops each having a size of about 5 μL.

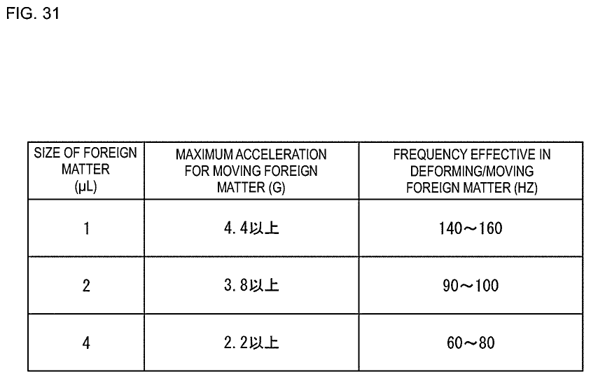

A frequency to be superposed may be changed in accordance with the size of foreign matter adhering to the light-transmitting body 510. FIG. 31 is a table showing maximum accelerations for moving foreign matter adhering to the light-transmitting body 510 and frequencies that are effective in realizing the maximum accelerations. For example, when the foreign matter is liquid drops each having a size of 1 μL, the maximum acceleration may be 4.4 G or higher in order to move foreign matter to remove the foreign matter from the light-transmitting body 510. In this case, it is possible to efficiently remove the foreign matter by causing the actuator to vibrate at a frequency in the range of about 140 Hz to 160 Hz. That is, the second resonant frequency when the size of the foreign matter is 1 μL is in the range of 140 Hz to 160 Hz. When the size of foreign matter is 1 μL, it is possible to efficiently remove the foreign matter by causing the actuator 530 to vibrate at a modulation frequency in which the second resonant frequency in the range of 140 Hz to 160 Hz is superposed on the first resonant frequency. For example, by changing a second resonant frequency to be superposed in accordance with the size of foreign matter, it is possible to more efficiently remove the foreign matter on the light-transmitting body 510.

The housing 9 according to the eighth example embodiment can provide the following advantageous effects.

By causing the actuator 530 to vibrate at a modulation frequency in which the first resonant frequency of the actuator 530 and the second resonant frequency of foreign matter are superposed, it is possible to promote deformation of the foreign matter and to efficiently remove the foreign matter from the light-transmitting body 510.

### INDUSTRIAL APPLICABILITY

Housing and sensor devices according to example embodiments of the present invention are applicable to optical sensors of, for example, an on-vehicle camera, or an optical sensor such as a LiDAR or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A housing containing an optical sensor, comprising:
a light-transmitting body;
a housing base to contain the optical sensor, the housing base holding the light-transmitting body in such that the light-transmitting body is able to vibrate; and
one or a plurality of actuators that vibrate the light-transmitting body.

2. The housing according to claim 1, wherein
the one or plurality of actuators each include a coil to generate a magnetic field when an electric current flows therethrough, a core provided a hollow of the coil and supporting the light-transmitting body, and a magnet to attract the core due to the magnetic field generated by the coil; and
the one or plurality of actuators vibrate the light-transmitting body in an axial direction of the core.

3. The housing according to claim 1, wherein
the light-transmitting body has a plate shape;
the plurality of actuators include a first actuator and a second actuator; and
the first actuator is provided on one end portion side of the light-transmitting body, and the second actuator is provided on another end portion side of the light-transmitting body opposite to the first actuator.

4. The housing according to claim 3, wherein the first actuator and the second actuator oppose each other.

5. The housing according to claim 3, further comprising a detector to detect an output voltage of at least one actuator among the first actuator and the second actuator.

6. The housing according to claim 5, further comprising:
a controller to control vibrations of the one or plurality of actuators; wherein
the controller is configured or programmed to control vibrations of the plurality of actuators based on the output voltage of the at least one actuator detected by the detector.

7. The housing according to claim 3, wherein the plurality of actuators vibrate the light-transmitting body in a direction that intersects a thickness direction of the light-transmitting body.

8. The housing according to claim 1, wherein
the light-transmitting body has a plate shape including a first main surface positioned outside and a second main surface opposite to the first main surface; and
the plurality of actuators are provided on the second main surface side of the light-transmitting body.

9. The housing according to claim 8, wherein the plurality of actuators vibrate the light-transmitting body in a thickness direction of the light-transmitting body.

10. The housing according to claim 1, wherein
the light-transmitting body has a cylindrical or substantially cylindrical shape including a first end portion and a second end portion opposite to the first end portion; and
the plurality of actuators are arranged at regular intervals on at least one of the first end portion side and the second end portion side.

11. The housing according to claim 10, wherein the plurality of actuators vibrate the light-transmitting body in an axial direction of the cylindrical or substantially cylindrical shape.

12. The housing according to claim 1, wherein
the actuator includes a piezoelectric element;
the housing base includes a vibration-transmitting portion to connect the actuator and the light-transmitting body and to transmit vibration to the light-transmitting body;
the light-transmitting body has a plate shape including a first main surface positioned outside, a second main surface opposite to the first main surface, and a side surface connecting the first main surface and the second main surface;
the vibration-transmitting portion includes a first vibration-transmitting portion and a second vibration-transmitting portion;
the first vibration-transmitting portion and the second vibration-transmitting portion each include a vibration portion and a support portion, the vibration portion including one end portion and another end portion, the one end portion being connected to the actuator, and extending along the side surface, the support portion extending from the another end portion of the vibration portion toward the side surface and supporting the light-transmitting body; and
the support portions, respectively, of the first vibration-transmitting portion and the second vibration-transmitting portion oppose each other and support the side surface of the light-transmitting body therebetween.

13. The housing according to claim 12, wherein
the actuator vibrates in a first direction that intersects a direction in which the support portions, respectively, of the first vibration-transmitting portion and the second vibration-transmitting portion oppose each other and in which the first main surface of the light-transmitting body extends; and
the support portions are provided at a center of the side surface in the first direction.

14. The housing according to claim 12, wherein
the actuator vibrates in a first direction that intersects a direction in which the support portions, respectively, of the first vibration-transmitting portion and the second vibration-transmitting portion oppose each other and in which the first main surface of the light-transmitting body extends; and
the support portions are closer to the actuator than to a center in the first direction.

15. The housing according to claim 1, wherein
the one or plurality of actuators each include a unimorph or bimorph piezoelectric element; and
the housing base includes a frame supporting the light-transmitting body and a connection portion connecting the light-transmitting body and the one or plurality of actuators.

16. The housing according to claim 12, further comprising:
a controller to control the actuator; wherein
the controller causes the actuator to vibrate at a modulation frequency in which a first resonant frequency of the actuator and a second resonant frequency of foreign matter adhering to the light-transmitting body are superposed.

17. The housing according to claim 1, wherein the housing base includes an elastic body to absorb vibration of the light-transmitting body.

18. The housing according to claim 1, wherein a cushioning portion is provided between the light-transmitting body and the housing base or between the light-transmitting body and the optical sensor.

19. The housing according to claim 18, wherein the cushioning portion includes a bellows structure.

20. The housing according to claim 18, wherein the cushioning portion is made of an elastomer.

21. A sensor device comprising:
the housing according to claim 1; and
an optical sensor included in the housing.
